(19) United States
(12) Patent Application Publication
(10) Pub. No.: US 2014/0275438 A1
(43) Pub. Date: Sep. 18, 2014

(54) Bulk Hydrophilic Functionalization of Polyamide 46

(71) Applicant: EDUCTIVE AB, Boras (SE)

(72) Inventors: Hamidreza Barghi, Boras (SE); Mohammad Taherzadeh, Hisings Backa (SE)

(21) Appl. No.: 14/352,282

(22) PCT Filed: Oct. 17, 2012
(86) PCT No.: PCT/SE2012/051109

§ 371 Date: Apr. 16, 2014

Related U.S. Application Data
(60) Provisional application No. 61/627,758, filed on Oct. 17, 2011.

(51) Int. Cl. C08G 69/50; C08G 69/48

(52) U.S. Cl. CPC C08G 69/50; C08G 69/48
USPC 525/427; 525/420

(57) ABSTRACT

A modified polymer as result of a bulk functionalization of polyamide 46 (PA 46) is presented, as well as methods for synthesizing the modified polymer. This functionalization of PA 46 is performed to provide a homogenous semi-permeable polyamide 46 capable of different charges and different porosities with particles of nanoscale size in order to replace or improve other polyamide fibers used in the textile industry, filtering processes, selective sorption, controlled release devices, phase transfer catalysts, chromatography media, biocompatible capsules, artificial skins, organs, bone void repair as well as in cell bioreactors and incubators, dental implements, medical devices, clothing, detectors, perfusion devices, in regenerative medicine, and fuel cells.

### FIELD OF THE INVENTION

The present invention relates to methods for bulk modifications of polyamide 46 (PA 46) and a novel bulk hydrophilic modification of polyamide 46. The methods are used to synthesize a novel bulk non-ionic, hydrophilic hydroxymethylated, hydroxyethylated, hydroxypropylated, and anionic carboxymethylated, carboxyethylated, succiniated and/or maleated derivatives of PA 46. The invention also relates to the use of the novel polymer in various embodiments.

### BACKGROUND OF THE INVENTION

Due to the high order structure and low ratio of methylene to amide groups, polyamide 46 has a very limited range of solvents for processing and modification. In addition, the solvents of PA 46 are not able to highly dissolve this polymer as a continuous phase (it only disperses at a high concentration in the relevant solvent). Therefore bulk modifications are very difficult.

The present invention is directed toward a bulk functionalization of polyamide 46 in order to provide a homogenous semi-permeable polyamide 46 aiming to substitute other polyamide fibers such as required for textile industry, filtering processes, selective sorption, controlled release devices, phase transfer catalysts, chromatographic media, biocompatible capsules, artificial skins and organs, and fuel cells. Polyamide 46 has good mechanical, physical and chemical properties compared to other aliphatic polyamides due to the lowest ratio of methylene to amide and therefore the highest crystallinity.

Polyamides modification is a known process (for example surface modifications), but the techniques that have been used do not provide bulk modifications of PA 46 like in the present invention. Due to the absence of active functional groups PA 46 is not able to load and immobilize common active materials into its structure. Further surface functionalization does not give the appropriate bonding between the polymer and other components and these types of functionalization therefore results in easily removing or washing out these surface loaded components.

EP2060315 discloses an invention that relates to hydrophilic micro-porous membranes. In this application some carrier hydrophilic materials such as zeolite, alumina and silica are blended with polymers. The membranes of EP2060315 are brittle and not flexible and therefore need to be relatively thick, if strength is desired.

### SUMMARY OF THE INVENTION

The invention herein discloses a new modified polymer, a bulk functionalized polyamide 46. The present invention also describes methods of synthesis of named modified polymer.

This functionalization of PA 46 was considered to provide a homogenous semi-permeable polyamide 46 with different charges and different porosities with nano scale diameter in order to replace other polyamide fibers required for the textile industry, filtering processes, selective sorption, controlled release devices, phase transfer catalysts, chromatography media, biocompatible capsules, artificial skins, organs and fuel cells.

Due to its low ratio of methylene to amide, PA 46 has higher crystallinity than other polyamides and it has good mechanical, physical and chemical properties. Bulk functionalization of this polyamide improves the other properties of PA 46, and in contrast to surface modifications, the bulk modifications will allow further processing of the modified polymer while still retaining the new characteristics.

Further processing, including but not limited to melting of the modified polymer will not substantially affect its new characteristics and therefore the new polymer will preserve most of its characteristics even after further processing.

### BRIEF DESCRIPTION OF THE FIGURES

FIG. 1. The mechanism of synthesis of poly[N-(4-aminobutyl)-N-(1-hydroxyethyl)-6-oxohexanamide] via reaction of poly[N-(4-aminobutyl)-6-oxohexanamide] with acetic aldehyde in the presence of aluminium chloride as Lewis acid catalyst.

FIG. 2. Water droplet on solid surface; liquid-gas surface tension (γ_{LG}), solid-gas surface tension (γ_{SG}), solid-liquid (γ_{SL}), drop height (h), drop radius (r), angle of drop to the surface (θ)

FIG. 3. Surface tension (mJ/m²) of PA 46 at different modification times. The bars represent standard errors (n=3).

FIG. 4. Transmittance IR spectrums: A) the unmodified PA 46, B) functionalized PA 46, C) Functionalized PA 46 after heat treated at 200±15° C.

FIG. 5. ¹H-NMR spectrum of unmodified PA 46 in DCOOD at 20° C.

FIG. 6. ¹H-NMR spectrum of modified PA 46 in DCOOD at 20° C.

FIG. 7. Differential scanning calorimetry (DSC) of the unmodified PA 46 (a,b) and modified PA 46 (c,d). The (a) and (c) thermograms represent cooling curves, while (b) and (d) thermograms represent heating curves

FIG. 8. Weight loss thermogram (TGA) of (a) the unmodified, completed and (b) functionalized PA 46. First transition temperature (A), second transition temperature (B), third transition temperature (C), forth transition temperature (D), fifth transition temperature (E) are presented.

FIG. 9. Molecular orientation of dimer-PA 46.

FIG. 10. Molecular orientation of dimer-hydroxyethyl PA 46.

FIG. 11. SEM micrograph of PA 46 (A,B) and hydroxyethyl PA 46 (C,D)

### DETAILED DESCRIPTION OF THE INVENTION

The present invention provides a new modified polymer and methods of synthesizing the bulk functionalized polyamide 46. This new polymer retains the basic characteristics of PA 46 and at the same time has some improved features, such as for example water absorbance.

The modified polyamide 46 disclosed in the present invention may be used in various embodiments including but not limited to a substitute for fibers required for textile industry, filtering processes, selective sorption, controlled release devices, phase transfer catalysts, chromatographic media, biocompatible capsules, and artificial skins and organs. This new polymer may also be used for water treatment, as a scaffold for wound healing, hemodialysis filters, immobilization of enzymes as biocatalysts and antiseptic and hygienic membranes.

The semi-permeable polyamide 46 may be used for capsules for encapsulation of industrial microorganisms.

The modified polymer may further be used to provide embedment nanoparticles into the polyamide 46 in a homogenous phase for biological, medical, pharmaceutical, cosmetic and toiletry applications.

The present invention discloses a bulk functionalized PA 46, which implies binding components in the bulk of the polymer and not only at the surface. This bulk modification advantageously provides a durable and recyclable polymer with good physical and chemical properties, which will have less impact on the environment. This is not possible with surface modifications, since such functionalization cannot give the appropriate binding between the polymer and other components.

The advantage of bulk modification is a recyclable and durable polymer after dissolution in a relevant solvent or reprocessing by melting without changing any properties in order to re-use several times, unlike surface modification where any dissolution or re-melting can destroy the surface of the modified polymer. Therefore, for re-using a surface modified polymer it is necessary to regenerate the surface modification if the previous surface modification method was not a destructive method such as plasma induced modification. Another advantage of bulk modification is that the shape of the polymer is under control, which means that one can easily give any shape to the polymer by melting, by dissolving in solvent, or by coating other materials such as metals, glass or natural fibers as properties enhancer. Moreover, bulk functionalized PA 46 may be used as stationary phase in chromatography, as ion exchanger in water treatment, as matrix for immobilization of enzymes, as a biocatalyst, as well as for immobilization of nanoparticles or drugs in their networks for drug delivery systems, which are stable and durable in any environments.

As a result of the modification of polyamide 46 the inventors obtained a novel, new polymer showing increased water absorbance, and a corresponding markedly increased contact angle 44.6 mJ/m² compared to 11.2 mJ/m² for polyamide 46. Additionally, the modified polymer has increased melting temperature, crystallinity and thermal properties. The high crystallinity of the new polymer provides a better resistance against mechanical and physical stress.

### Materials and Methods

### Example 1

Polyamide 46 (Stanyl TW300, Mₙ˜24000 g/mol), supplied by DSM Engineering Plastic (DSM Scandinavia AB, Sweden) was heated up to 50±2° C. in an oven for 3 h, followed by desiccation to reach constant weight. Gradually, 10 g of dried polyamide was added to 80 mL formic acid ≧98% (1.22 g/mL at 25° C.) and stirred gently for 2 h to obtain continuous dispersion at this concentration. Then, 10 mL ethanol 99.8% (0.791 g/mL at 25° C.) and 42 mL dimethyl sulfoxide ≧99.5% (1.10 g/mL at 25° C.) were added to this mixture. The solution was then poured into a 500 ml three-neck round bottom flask, which was immersed in a water bath and connected to a thermometer. This was followed by the addition of 1.82 g of anhydrous AlCl₃ (purity ≧99.9%). The temperature was then kept at 75±2° C. for 1 h. After complete dissolution of the AlCl₃ in the polymer solution, the temperature was decreased to room temperature. Then, due to the exothermic reaction of the aldehyde and aluminum complex, 10 mL acetaldehyde ≧99% (0.785 g/ml at 25° C.) was added very slowly. The flask was equipped with a condenser; the temperature was adjusted to 55±2° C. and kept constant for 1 to 3 h. After cooling to room temperature, this solution was then mixed with 200 mL ethanol (≧99%) and stirred for 15 min in order to precipitate the polymer. The polymer was removed by centrifugation at 10000×g for 5 min. This step was repeated with 100 mL mixture of 80 mL ethanol 70% and 20 mL ammonium hydroxide 20% at room temperature in order to remove any aldehyde and aluminum salts residues. The modified polymer was taken off and dried in oven at 50° C. for 3 h and ground into granulates for further analysis.

### Determination of Hydrophilicity

Hydrophilicity of the polymers was determined employing contact angle measurement apparatus via dropping a certain amount of water on an area of solid film, followed by examining the spreading of water on the hydrophilized surface by means of developing liquid-solid interface. A droplet of liquid after contact with a solid film makes an angle between interfaces of liquid and solid surfaces. The angle of the droplet is monitoring as interfacial forces of liquid/vapor/solid (FIG. 2). The contact angle of a droplet is measured using equation (1)^{[6]}:

$$θ = 90 - {tan}^{- 1} ( \frac{r - h}{\sqrt{2 rh - {h}^{2}}} ) \qquad ( 1 )$$

where r is radius and h is height of the droplet.

For the analysis, polymer films were produced by dissolution of 5 g polymers in 30 mL formic acid, which then was poured into a glass mold and dried in oven at 50° C. Film specimens were then cut off to a dimension of 14×140×0.16 mm, followed by fixing the film on the film holder of dynamic absorption tester (model Fibro's DAT 1100, Thwing-Albert instrument Co., USA). Ten μl Millipore tap water with a surface tension 72.5 mJ/m² was then dropped on the polymer film with thickness 0.16 mm. The contact angle of droplet as a functional of time was studied. Contact angle measurement (CAM) provides information regarding the bonding energy at solid/liquid/gas interfaces, to obtain information regarding wetting, adhesion, and absorption properties. When a droplet of liquid with high surface tension is placed on a surface with lower surface energy, the liquid repels the surface and a spherical shape occurs (lowest energy shape).

The surface tension reached its maximum value 2 h after the treatment with acetaldehyde. No further reaction was observed after 2 h, which is the optimal reaction time. Hydrophilization with acetaldehyde gave clearly higher surface tension (γ_{SL}) between the water-polymer interface. The increasing of γ_{SL} from 11.2 to 44.6 mJ/m² corresponded directly to formed hydrogen bonds between water molecules and the hydroxyethyl groups on the PA 46 backbone. The results show that there is an increase in surface tension after the first hour of modification. This is obviously related to added hydroxyl groups and the promoted hydrogen bonding at the water-solid interface. The contact angle of a water droplet on unmodified polyamide 46 changed from 58.3 to 35.0 degrees after one hour of modification and after two and three hours, this value decreased further to 31.8 and 30.1 degrees, respectively. In contrary, the wetting area increased during the modification from 17.48 mm² for unmodified PA up to a maximum of 21.96 mm² for three hours modification. These results show the maximum modification after 3 h; however, most of activated nitrogen atoms are substituted after the first hour of the modification.

### Chemical Structure Analyses

Functional groups in the bulk polymer were studied using FTIR (Nicolet iS10, Thermo Scientific, Waltham, USA) in a transmittance range between 600 and 4000 cm⁻¹. The functionalization reaction was monitored from the peak at 1020 cm⁻¹ indicating the formed —C—O— bond, and from the broad peak between 3400 and 3600 cm⁻¹ indicating the —OH group, which both are proof of the substituted carbinol (—CH₂OH). The obtained polymer was also studied by ¹H-NMR spectroscopy (Bruker 400 MHz, Germany). The hydrophilized polymer (20 mg) was dissolved in 500 μL DCOOD, and then transferred into the NMR glass tube. After adjusting the suitable regulation (lock gain 30, lock level 180, lock phase 265.7) the ¹H-NMR spectrum was recorded.

FTIR analysis was used as a means to detect functional groups in both unmodified PA 46 and modified PA 46. The amide groups can be identified by very strong bands at 3298 cm⁻¹ for hydrogen bonded N—H stretching, at 3077 cm⁻¹ for amide II, at 1634 cm⁻¹ attributed engaged C═O, at 1537 cm⁻¹ for C—N stretching, at 1279 for amide III, 940 cm⁻¹ for amide IV, and at 688 cm⁻¹ for N—H out of plane bending. The intensive bands at 2943 cm⁻¹ and 2869 cm⁻¹ are due to the presence of CH₂ segments in the polymer backbone. An overlaid broad band between 3150 cm⁻¹ and 3600 cm⁻¹ is attributed to O—H and N—H groups. A peak at 1020 cm⁻¹ can be ascribed to C—O stretching corresponding to the methylol segments. The stretching peak of C═O at 1738 cm⁻¹ is clearly observed. Finally, the peaks between 1350 and 1480 cm⁻¹ reveal C—H bending. Comparison between transmittance spectra of PA 46, hydrophilized and heat treated hydrophilized PA 46 clearly shows that the wave number and intensity of the characteristic absorption bands of CH₂ groups and amide fragments were changed. At the range of 3500-3000 cm⁻¹, increases in the intensity band at around 3290 cm⁻¹ indicates to the improvement of hydrogen bonds in the modified PA 46 compare to unmodified PA 46. Moreover, presence of a peak at 1020 cm⁻¹ indicates the introduced —C—O— segments. The intensity and splitting of the C—H peak at 1464 cm⁻¹ attributes to the vibration of the C—H with the adjacent conjugated N—H groups, moreover, both 1282 cm⁻¹ and 1464 cm⁻¹ peaks shift to higher wave length. These changes probably are due to extend of the liberation motion between C—H and amide bonds. Any changes in the other peaks such as 1362, 1282, 1197 and 1140 cm⁻¹ reveal vibration of methylene sequences.

The ¹H-NMR spectra show the chemical structure of PA 46 and modified PA 46 which can be identified by the chemical shifts (δ) and yield of reaction. The chemical shifts 1.98, 2.02, 2.06, 2.10, and 2.14 ppm are attributed to —CH₂ protons which are close to carbonyl groups and far from carbonyl and amide groups. Whereas protons of —CH₂ which are close to amide groups appeared at higher chemicals shift as 3.86 ppm. This is related to higher resonance of nitrogen electrons in magnetic field compare to entrapped sp² electrons of oxygen in carbonyl groups where are adjacent to —CH₂. In the modified polymer overlaid peaks were observed at separated chemical shifts (3.82 and 3.88 ppm) and were attributed to protons of hydroxyl groups, adjacent —CH to hydroxyl as well as to two types of —CH₂ protons attached to —NH having similar chemical shifts. At 8.72 ppm was observed the amidic proton directly connect to nitrogen. According to these results, the amount of amidic proton in commercial PA 46 was 1.766% g/g whereas in the hydroxyethylated derivative this amount was reduced to 0.076% g/g. This proton indicated the yield of reaction: 95.65%. The chemical shifts at 10.36, 10.45, 11.19 and 12.9 ppm could be associated to some residues of adipic acid or terminally carboxylic groups in both unmodified and modified polymers. Moreover, the intensive peak at chemical shift 11.63 ppm, could be related to some residues of formats in hydroxyethyl PA.

### Thermal Analysis

The thermal properties of modified PA 46 were studied by differential scaningcalorimetry (DSC) and thermogravimetric analysis (TGA). Approximately 8 mg of the modified and unmodified polyamide 46 were placed in a DSC (Q2000, TA Instruments, Delaware, USA). The heating and cooling scan rates were 10° C. min⁻¹, and the analysis was done under nitrogen gas with flow rate 50 mL/min. The samples were scanned from 30° C. to 320° C. The thermal stability was determined by TGA. The analysis was performed on both polyamide 46 and modified polymer for comparison. Ten mg sample was loaded into the auto-sampler of the apparatus (TGA Q500, TA Instruments, Delaware, USA), and thereafter heated at a heating rate of 10° C./min, from 20° C. up to 700° C. under nitrogen atmosphere with flow rate 50 mL/min.

The TGA curve in FIG. 7 indicates less thermal stability for the hydrophilized PA compared to the neat PA 46. This could be due to lower heat stability of hydroxyethyl pendant groups, which can find explanation in the electron withdrawing effect of electronegative elements (N, O) which are bonded on a single carbon atom (carbon 2°), resulting in dehydration and breakdown of the hydroxyethyl substituents at elevated temperature. Although methyl group in hydroxyethyl segments is an electron donor which is able to moderate electrons withdrawing affect on the carbon 2°. FIG. 7 shows that the thermal stability of the unmodified polyamide is good up to 414.19° C. Above this temperature, a 92.34% weight loss was observed, which increased to 95% weight loss at 600° C. Hence, observation of the two decompositions in unmodified polymer implies to homogenous heat properties of PA 46. In modified PA 46, was observed a 6.5% weight loss at 193.35° C. which corresponds to release of inter-molecular water content of this polymer. A two-steps weight loss appears after 193.35° C., which illustrates the starting of the decomposition of the hydroxyethyl segments into volatile components as H₂O and CO. The decomposition occurs up to 320.13° C. The total weight loss at this stage is 8.95%. These means that 8.95% total weight of polymer is concerning pendant functional groups and some volatile components such as water. If we consider the percentage of modification obtained by ¹H-NMR as 95.65% the total intermolecular water content in this polymer is 4.6% and 4.35% is related to 1-hydroxyethyl side groups. Therefore, any changes in the weight of the polymers at higher temperature only depend on releasing volatile segments in absence of oxygen. The second drop in the weight loss is related to the starting of decomposition of the polymeric backbone with a steep ramp from 385.53° C. up to 454.88° C. This second transition state attributes to completely decomposition of the polymer backbone. Decomposition of hydroxyethyl groups suggests an unstable structure due to disproportionate electron share on the polymer backbone, resulting in enhancement of polymer chains decomposition.

### Morphological Study

Micrograph of modified and unmodified PA 46 using “Environmental scanning electron microscope” (ESEM-FEI Quanta 200F, Oregon, USA) is obtained after attachment the film of samples on the carbon conductive tabs, then it was located on the aluminum tilt in vacuum chamber, the pressure was set on 1 torr and voltage was set on 10 kV at 15° C.

The substitution of hydroxyethyl on amidic nitrogen clearly increases the bending of polymer chains, while molecular orientation of neat PA 46 is planar zigzag conformation. According to this model, PA 46 has no any spaces between two chains resulting in very close and compact network. After modification, the molecular orientation converted to three-dimensional spherical distribution (FIG. 10, 11) which leads to the higher surface area and sparse network. The reason for configuration change is attributed to repulsive forces between adjacent bulky hydroxyl side groups resulting in bending the polymeric backbone and creating a low density spherical network.

### Example 2

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% solution (1.22 g/mL at 25° C.) by mixing and warming at 55±2° C. This process was followed by adding 20 mL solution of formaldehyde in water ˜37% to this mixture. The temperature was increased and kept at 55±2° C. for 1 h. After complete reaction and providing a viscous solution the temperature was adjusted at room temperature. Then, to this cloudy solution was added 250 mL methanol (≧99%) and mixed for 5 min. The high sticky polymer was taken off by phase separation in a decanter. This stage was repeated 2 times in order to remove any residual of formaldehyde. The polymer paste was then dried at 50° C. for 6 h in an oven.

### Example 3

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by stirring. This process following by adding 20 mL Dimethyl sulfoxide ≧99.5% (1.10 g/mL at 25° C.) and 42 mL dimethyl sulfoxide ≧99.5% (1.10 g/mL at 25° C.) to this mixture. The temperature was increased and kept at 67° C. for 1 h. After complete reaction and providing transparent orange-red solution the temperature was reduced to room temperature. Then, 11.34 mL acetaldehyde ≧99% (0.785 g/ml at 25° C.) to this solution was added. Afterward, the temperature was fixed at 70±2° C. for 20 min. After decreasing down the temperature at 25±2° C. to this light yellowish solution was added 250 mL methanol (≧99%) and mixed for 5 min. The suspended white precipitate of modified polyamide was taken off by 2 times centrifugation at 9000×g for 10 min. This stage was repeated two times. The modified polymer was then removed off and dried at 50° C. for 6 h.

### Example 4

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by gently mixing and heating at 50±2° C. This process was followed by adding 24 mL dimethyl sulfoxide (DMSO)≧99.8% (1.10 g/mL at 25° C.) to this mixture. The temperature was increased and kept at 65±2° C. for 15 min to obtain transparent orange-red solution. After complete reaction the temperature was reduced to room temperature. Then, 12.4 mL propionaldehyde ˜97% (0.81 g/ml at 25° C.) to this solution was added and the temperature was fixed at 65±2° C. for 30 min. After decreasing the temperature to 25±2° C. to this clear white off solution was added 300 mL methanol (≧99%) and mixed for 5 min. The suspended white precipitate modified polyamide was taken off by centrifugation at 9000×g for 10 min. This stage was repeated 2 times. The modified polymer was then removed off and dried at 50° C. for 6 h.

### Example 5

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by gently mixing and heating at 50±2° C. This process was followed by adding 20 mL dimethyl sulfoxide (DMSO)≧99.5% (1.10 g/mL at 25° C.) to this mixture. The temperature was increased and kept at 70±2° C. for 15 min to obtain transparent orange-red solution. After complete reaction the temperature was reduced to room temperature. Then, 7.4 g maleic anhydride ≧99% to this solution was added and the temperature was fixed at 65±2° C. for 40 min until all reagents reacted to each other and transparence light orange liquid was obtained. After decreasing the temperature to 25±2° C. to this clear solution was then added 300 mL methanol (≧99%) and mixed for 5 min. The suspended white precipitate modified polyamide was taken off by centrifugation at 9000×g for 10 min. This stage was repeated 2 times. The modified polymer was then removed off and dried at 50° C. for 6 h.

### Example 6

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by gently mixing and heating at 50±2° C. This process was followed by adding 20 mL dimethyl sulfoxide (DMSO)≧99.5% (1.10 g/mL at 25° C.) to this mixture. The temperature was increased and kept at 70±2° C. for 15 min to obtain transparent orange-red solution. After complete reaction the temperature was reduced to room temperature. Then, 7.7 g succinic anhydride ≧99% to this solution was added and the temperature was fixed at 65±2° C. for 40 min until all reagents reacted to each other and transparence light orange liquid was obtained. After decreasing the temperature to 25±2° C. to this clear solution was then added 300 mL methanol (≧99%) and mixed for 5 min. The suspended white precipitate modified polyamide was taken off by centrifugation at 9000×g for 10 min. This stage was repeated 2 times. The modified polymer was then removed off and dried at 50° C. for 6 h.

### Example 7

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by gently mixing and heating at 50±2° C. This process was followed by adding 20 mL dimethyl sulfoxide (DMSO)≧99.5% (1.10 g/mL at 25° C.) to this mixture. The temperature was increased and kept at 70±2° C. for 15 min to obtain transparent orange-red solution. After complete reaction the temperature was reduced to room temperature. Then, 7.1 g monochloroaceticacid ≧99% to this solution was added and the temperature was fixed at 65±2° C. for 40 min until all reagents reacted to each other and transparence light orange liquid was obtained. After decreasing the temperature to 25±2° C. to this clear solution was then added 300 mL methanol (≧99%) and mixed for 5 min. The suspended white precipitate modified polyamide was taken off by centrifugation at 9000×g for 10 min. This stage was repeated 2 times. The modified polymer was then removed off and dried at 50° C. for 6 h.

### Example 8

15 g polyamide 46 (Stanyl TW300, Mₙ˜24000 g/mol) supplied by DSM engineering plastic (DSM Scandinavia AB, Sweden) was dried in an oven for 1 h at 55±2° C. The dried polyamide 46 was dispersed in to 100 mL formic acid ≧98% (1.22 g/mL at 25° C.) by gently mixing and heating at 50±2° C. This process was followed by adding 20 mL dimethyl sulfoxide (DMSO)≧99.5% (1.10 g/mL at 25° C.) to this mixture. The temperature was increased and kept at 70±2° C. for 15 min to obtain transparent orange-red solution. After complete reaction the temperature was reduced to room temperature. Then, 7.8 g 2-chloropropionic acid ˜99% to this solution was added and the temperature was fixed at 65±2° C. for 40 min until all reagents reacted to each other and transparence light orange liquid was obtained. After decreasing the temperature to 25±2° C. to this clear solution was then added 300 mL methanol (≧99%) and mixed for 5 min. The suspended white precipitate modified polyamide was taken off by centrifugation at 9000×g for 10 min. This stage was repeated 2 times. The modified polymer was then removed off and dried at 50° C. for 6 h.

### Experimental Section

### Synthesis of poly[N-(4-aminobutyl)-N-(1-hydroxyethyl)-6-oxohexanamide]

Polyamide 46 (Stanyl TW300, Mₙ˜24000 g/mol) supplied by DSM Engineering Plastic (DSM Scandinavia AB, Sweden) was heated up to 50±2° C. in an oven for 3 h, followed by desiccation to reach constant weight. Gradually, 10 g of dried polyamide was added to 80 mL formic acid ≧98% (1.22 g/mL at 25° C.) and stirred gently for 2 h to obtain continuous dispersion at this concentration. Then, 10 mL ethanol 99.8% (0.791 g/mL at 25° C.) and 42 mL dimethyl sulfoxide ≧99.5% (1.10 g/mL at 25° C.) were added to this mixture. The solution was then poured into a 500 ml three-neck round bottom flask, which was immersed in a water bath and connected to a thermometer. This was followed by the addition of 1.82 g of anhydrous AlCl₃ (purity ≧99.9%). The temperature was then kept at 75±2° C. for 1 h. After complete dissolution of the AlCl₃ in the polymer solution, the temperature was decreased to room temperature. Then, due to the exothermic reaction of the aldehyde and aluminum complex, 10 mL acetaldehyde ≧99% (0.785 g/ml at 25° C.) was added very slowly. The flask was equipped with a condenser; the temperature was adjusted to 55±2° C. and kept constant for 1 to 3 h. After cooling to room temperature, this solution was then mixed with 200 mL ethanol (≧99%) and stirred for 15 min in order to precipitate the polymer. The polymer was removed by centrifugation at 10000×g for 5 min. This step was repeated with 100 mL mixture of 80 mL ethanol 70% and 20 mL ammonium hydroxide 20% at room temperature in order to remove any aldehyde and aluminum salts residues. The modified polymer was taken off and dried in oven at 50° C. for 3 h and ground into granulates for further analysis. The proposed mechanism of the reaction is shown in FIG. 1.

### Determination of Hydrophilicity

Hydrophilicity of the polymers was determined employing contact angle measurement apparatus via dropping a certain amount of water on an area of solid film, followed by examining the spreading of water on the hydrophilized surface by means of developing liquid-solid interface. A droplet of liquid after contact with a solid film makes an angle between interfaces of liquid and solid surfaces. The angle of the droplet is monitoring as an interfacial forces of liquid/vapor/solid (FIG. 2). The contact angle of a droplet is measured using equation (1)^{[6]}:

$$θ = 90 - {tan}^{- 1} ( \frac{r - h}{\sqrt{2 rh - {h}^{2}}} ) \qquad ( 1 )$$

where r is radius and h is height of the droplet.

For the analysis polymer films were made by dissolution of 5 g polymers in 30 mL formic acid, then poured into a glass mold and dried in oven at 50° C. Film specimens were then cut off to a dimension of 14×140×0.16 mm. The film was then fixed on the film holder of dynamic absorption tester (model Fibro's DAT 1100, Thwing-Albert instrument Co., USA). Ten μl tapped water with a surface tension 72.5 mJ/m² was then dropped on the polymer film with thickness 0.16 mm. The contact angle of droplet as a functional of time was studied.

### Chemical Structure Analyses

Functional groups in the bulk polymer were studied using FTIR (Nicolet iS10, Thermo Scientific, Waltham, USA) in a transmittance range between 600 and 4000 cm⁻¹. The functionalization reaction was verified from, the peak at 1020 cm⁻¹ indicating the formed —C—O— bond, and from the broad peak between 3400 and 3600 cm⁻¹ indicating the —OH group which both are proof of the substituted carbinol (—CH₂OH)^{[7]}. The obtained polymer was also studied by ¹H-NMR spectroscopy (Bruker 400 MHz, Germany). The hydrophilized polymer (20 mg) was dissolved in 500 μL DCOOD, and then transferred into an NMR glass tube. After adjusting the suitable regulation (lock gain 30, lock level 180, lock phase 265.7, followed by shimming) the ¹H-NMR spectrum was recorded.

### Thermal Analysis and Morphological Study

The thermal properties of modified PA 46 were studied by differential scanning calorimetry (DSC) and thermogravimetric analysis (TGA). Approximately 8 mg of the modified and unmodified polyamide 46 were placed in a DSC (Q2000, TA Instruments, Delaware, USA). The heating and cooling scan rates were 5° C. min⁻¹, and the analysis was done under nitrogen gas with a flow rate of 50 mL/min. The samples were scanned from 30° C. to 320° C. The thermal stability was determined by TGA. The analysis was performed on both polyamide 46 and modified polymer for comparison. Ten mg sample was loaded into the auto-sampler of the apparatus (TGA Q500, TA Instruments, Delaware, USA), and then heated at a heating rate of 10° C./min, from 20° C. up to 700° C. under nitrogen atmosphere with a flow rate of 50 mL/min. After attachment of the film sample on the carbon conductive tabs, and location on the aluminum tilt in vacuum chamber, the pressure was set on 1 torr and voltage on 10 kV at 15° C.; thereafter the micrographs of modified and unmodified PA 46 were recorded using “Environmental scanning electron microscope” (ESEM-FEI Quanta 200F, Oregon, USA).

### Results

Polyamide 46 is not permeable in water due to absence of hydrophilic groups. The object of this study was to increase the bulk hydrophilicity of this polymer by adding hydrophilic pendant functional groups. For this purpose, polyamide 46 was hydroxylated by adding a hydroxyethyl functional group on the amide nitrogen. Polyamide 46 as a highly stable aliphatic polyamide does not normally react in nucleophilic substitutions. In this study, polyamide 46 was modified by acetaldehyde in a continuous phase of mixed formic acid and DMSO. This reaction resembles the mechanism which is proposed for catalytic transamidation of less reactive amides (amide II and amide III) in the presence of Al^{+3 [8]}. Through the catalytic nucleophilic substitution reaction, less active amides in the presence of Lewis acid such as aluminum chloride are able to bind to carbonyl segments resulting in an intermediate alky aluminate complex. The lone electron pairs of the nitrogen is then freely ready for nucleophilic attack toward a carbocation like the 1-hydroxyethyl carbocation, which is obtained from acetaldehyde after protonation in low pH. This reaction shows a competent pathway for activation of less active amides II, even in high crystalline polymeric network such as polyamide 46. Activation of the amide II in polyamide 46 by introducing aluminum chloride was obtained in this study. The proposed mechanism for this reaction is illustrated in FIG. 1. The reaction proceeds by eliminating hydrochloric acid and results in an aluminum complex as intermediate. Aluminum chloride at low pH and elevated temperature creates ionic bonding with oxygen of carbonyl groups. This intermediate is able to eliminate resonative electron pairs between carbonyl and nitrogen, resulting in conversion of inactive amide II to an active amine II. The amine II then endures nucleophilic substitution by a carbocation, which is generated from acetaldehyde (FIG. 1). The result shows complete dissolution of 10 g PA 46 in mixture of formic acid and DMSO at a ratio 80:42 (v/v) in form of continuous phase (transparent solution) at 55° C. DMSO in this reaction has a role of quenching hydrogen exchanger^{[9]}, which can develop nucleophilic substitution reaction. The objective of adding 99% ethanol in this reaction was to remove impurities in the modified polymer without any solvolysis effects. Moreover, ammonium hydroxide (20%) was applied in order to eliminate aluminum complex in polymeric backbone and neutralize formic acid residues. The hydrophilized polyamide 46 was analysed regarding the hydrophilic and thermal properties, in addition to confirming chemical structure.

### Contact Angle Measurement (CAM)

Contact angle measurement (CAM) provides information regarding the bonding energy at solid/liquid/gas interfaces, to obtain information regarding wetting, adhesion, and absorption properties. When a droplet of liquid with high surface tension is placed on a surface with lower surface energy, the liquid repels the surface and a spherical shape occurs (lowest energy shape). FIG. 3 shows that the surface tension reached its maximum value 2 h after the treatment with acetaldehyde. No further reaction was obtained after 2 h, which is the optimal reaction time. Hydrophilization with acetaldehyde gave clearly higher surface tension (γ_{SL}) between the water-polymer interface. The increasing of γ_{SL} from 11.2 to 44.6 mJ/m² corresponded directly to formed hydrogen bonds between water molecules and the hydroxyethyl groups on the PA 46 backbone. The results show that there is an increase in surface tension after the first hour of modification. This is obviously related to added hydroxyl groups and the promoted hydrogen bonding at the water-solid interface. The contact angle of a water droplet on unmodified polyamide 46 changed from 58.3 to 35.0 degrees after one hour of modification and after two and three hours, this value decreased further to 31.8 and 30.1 degrees, respectively. In contrary, the wetting area increased during the modification from 17.48 mm² for unmodified PA up to a maximum of 21.96 mm² for three hours modification (Table.1). These results show the maximum modification after 3 h; however, most of activated nitrogen atoms are substituted after the first hour of modification.

TABLE 1
The contact angle and surface area at 0.2 s of the unmodified
and functionalized PA 46 after different reaction times
(values represent mean ± standard error, n = 3)

| Sample | Angle (°) | Area (mm²) |
|---|---|---|
| Controlled PA | 58.3 ± 0.1 | 17.48 ± 1.2 |
| 1 h modified | 35.0 ± 0.2 | 19.76 ± 1.3 |
| 2 h modified | 31.8 ± 0.4 | 21.33 ± 1.1 |
| 3 h modified | 30.1 ± 0.3 | 21.96 ± 1.2 |

### Chemical Structure Analysis Via Infrared Spectra (FT-IR)

FTIR analysis was used as means to detect functional groups in both unmodified PA 46 and the modified PA 46. FIG. 4 illustrates comparative FTIR transmittance spectra of the unmodified PA 46, modified PA 46, and modified PA 46 after heat treatment at 200±15° C. The amide groups can be seen by very strong bands at 3298 cm⁻¹ for hydrogen bonded N—H stretching, at 3077 cm⁻¹ for amide II, at 1634 cm⁻¹ attributed engaged C═O, at 1537 cm⁻¹ for C—N stretching, at 1279 for amide III, 940 cm⁻¹ for amide IV, and at 688 cm⁻¹ for N—H out of plane bending. The intensive bands at 2943 cm⁻¹ and 2869 cm⁻¹ are due to the presence of CH₂ segments in the polymer backbone. An overlaid broad band between 3150 cm⁻¹ and 3600 cm⁻¹ is attributed to O—H and N—H groups^{[10]}. A peak at 1020 cm⁻¹ can be ascribed to C—O stretching corresponding to the methylol segments. The stretching peak of C═O at 1738 cm⁻¹ is clearly observed. Finally, the peaks between 1350 and 1480 cm⁻¹ reveal C—H bending^{[10]}. Comparison between transmittance spectra of PA 46, hydrophilized and heat treated hydrophilized PA 46 clearly shows that the wave number and intensity of the characteristic absorption bands of CH₂ groups and amide fragments were changed. At the range of 3500-3000 cm⁻¹, increases in the intensity band at around 3290 cm⁻¹ indicates an improvement of hydrogen bonds in the modified PA 46 compare to unmodified PA 46^{[10]}. Moreover, presence of a peak at 1020 cm⁻¹ indicates the introduced —C—O— segments. The intensity and splitting of the C—H peak at 1464 cm⁻¹ attributes to the vibration of the C—H with the adjacent conjugated N—H groups. Moreover, both 1282 cm⁻¹ and 1464 cm⁻¹ peaks shift to higher wave length. These changes are attributed to an extend of the liberation motion between C—H and amide bonds. Any changes in the other peaks such as 1362, 1282, 1197 and 1140 cm⁻¹ reveal vibration of methylene sequences^{[10]}.

### Chemical Structure Analysis Via ¹H-NMR

The ¹H-NMR spectra (FIGS. 5 and 6) show the chemical structure of PA 46 and modified PA 46 which can be identified by the chemical shifts (δ) and yield of reaction. The chemical shifts at 1.98, 2.02, 2.06, 2.10, and 2.14 ppm were attributed to protons of —CH₂^{[11]} which are close to carbonyl groups and far from carbonyl and amide groups (positions a and b). Whereas protons of —CH₂ which are close to amide groups appeared at higher chemicals shift as 3.86 ppm (position c). This is related to higher resonance of nitrogen electrons in magnetic field compared to entrapped sp² electrons of oxygen in carbonyl groups adjacent to —CH₂^{[11]}. In the modified polymer overlaid signals were observed at separated chemical shifts (3.82 and 3.88 ppm) and were attributed to protons of hydroxyl groups (d), adjacent —CH to hydroxyl (e), as well as to two types of —CH₂ protons attached to —NH having similar chemical shifts (h, g). At 8.72 ppm was identified the amidic proton directly connected to nitrogen (i)^{[11]}. According to these results, the amount of amidic proton in commercial PA 46 was 1.766% g/g whereas in hydroxyethylated derivative, this amount was reduced to 0.076% g/g. This proton indicated the yield of reaction: 95.65%. Chemical shifts at 10.36, 10.45, 11.19 and 12.9 ppm could be identified to some residues of adipic acid or terminally carboxylic groups in both of unmodified and modified polymers. Moreover, the intensive peak at the chemical shift 11.63 ppm (FIG. 6) could be related to some residues of formats in hydroxyethylated PA.

### Diffraction Scanning Calorimetry

The polymer molecules, when reaching a specific cooling temperature, will have gained enough energy to move into maximum ordered structure with less entropy called crystallization temperature. The crystallization temperature (T_{c}) is a certain temperature, when the crystalline state is completely dominated. The area of the crystallization peak reflects the latent energy of crystallization or (ΔH_{c}). FIG. 6 shows the cooling and heating curves of unmodified and functionalized PA 46. After the modification, due to presence of O—H groups, the intermolecular hydrogen bonding in functionalized polymer is improved, therefore, the ordering and the crystallinity of the polymer should be increased. According to the cooling curves, the latent heat crystallization energy is decreased from 84.98 J/g in unmodified to 65.86 J/g in hydroxyethyl derivative (FIGS. 6a, 6c). The 19.12 J/g difference between these two crystallization energies indicates a 22.5% higher degree of crystallinity in the hydroxylated polyamide 46. Namely, the unmodified PA has 1.29 times more amorphous structure compared with hydroxyethylated derivative. In addition, the increase of Tₑ from 235° C. in the reference PA to 240° C. in the modified polyamide also attributes to developed hydrogen bonding due to the hydroxyl groups. Heating scanned thermograms show that the glass transition temperature (T_{g}) increased from 78.1° C. in unmodified to 86.23° C. in hydrophilized PA. Moreover, FIGS. 6b, 6d show that the melting point increased from 290.12° C. for the unmodified PA to 292.34° C. in hydroxyethylated derivative. Due to the higher degree of crystallinity of the functionalized polymer, more energy is required for reaching the melting temperature (Tₘ), which can be seen as 1.6 times higher melting enthalpy (ΔHₘ).

### Thermogravimetric Analysis

The TGA curve in FIG. 7 indicates less thermal stability for the hydrophilized PA compared with the neat PA 46. This is attributed to lower heat stability of hydroxyethyl pendant groups. Which can find explanation in the electrons withdrawing effect of electronegative elements (N, O) which are bonded on a single carbon atom (carbon 2°), resulting in dehydration and breakdown of the hydroxyethyl substituents at elevated temperature. Although methyl group in hydroxyethyl segments is an electron donor which is able to moderate electrons withdrawing affect on the carbon 2°. FIG. 7 shows that the thermal stability of the unmodified polyamide is good up to 414.19° C. Above this temperature, a 92.34% weight loss was observed, which increased to 95% weight loss at 600° C. Hence, observation of the two decompositions (A, B) in unmodified polymer implies to homogenous heat properties of PA 46. In modified PA 46, a 6.5% weight loss was observed at 193.35° C. which corresponds to release of inter-molecular water contents of this polymer. In FIG. 7B, a two-steps weight loss appears after 193.35° C., which illustrates the starting of the decomposition of the hydroxyethyl segments into volatile components such as H₂O and CO. The decomposition occurs up to 320.13° C. The total weight loss at this stage is 8.95%. This means that 8.95% total weight of polymer is concerning pendant functional groups and some volatile components such as water. Considering the percentage of modification obtained by ¹H-NMR as 95.65% the total intermolecular water content in this polymer (4.6% and 4.35%) is related to 1-hydroxyethyl side groups. Therefore, any changes in the weight of the polymers at higher temperature only depend on releasing volatile segments in absence of oxygen. The second drop in the weight loss (FIG. 7b) is related to the starting of decomposition of the polymeric backbone with a steep ramp from 385.53° C. up to 454.88° C. This second transition state attributes to completely decomposition of the polymer backbone. Decomposition of hydroxyethyl groups suggests an unstable structure due to disproportionated electron share on the polymer backbone, resulting in enhancement of polymer chains decomposition.

### Morphology Study

FIG. 11 shows the morphology of PA 46 and hydroxyethylated PA 46. The substitution of hydroxyethyl on amidic nitrogen clearly increases the bending of polymer chains, while molecular orientation of neat PA 46 is planar zigzag conformation. FIG. 9 shows dimer molecular models of PA 46 and hydroxyethylated PA 46 which are approved by SEM micrographs (FIG. 10). According to this model, PA 46 has no any spaces between two chains resulting in very close and compact network. After modification, the molecular orientation converted to three-dimensional spherical distribution (FIG. 10, 11) which leads to the higher surface area and sparse network. The reason for configuration change is attributed to repulsive forces between adjacent bulky hydroxyl side groups resulting in bending the polymeric backbone and creating a low density spherical network.

### CONCLUSIONS

The present invention relates to a substance comprising a bulk derivative of polyamide 46 and having formula I

[—NH—CH₂—CH₂—CH₂—CH₂—NR—CO—CH₂—CH₂—CH₂—CH₂—CO—]ₙ (formula I)

wherein R is hydroxyalkyl, acyl or carboxyalkyl and n is a natural number between 50 and 250, preferably between 100 and 150, more preferred between 115 and 125. Furthermore, the present invention relates to a method for preparing the bulk derivative of polyamide 46 (I), wherein the method comprises:
(a) reacting the polyamide 46 with an aldehyde having formula (II), or a carbonyl compound having formula (III) or a carboxylic acid having formula (IV)

R¹COH (II),

R²COY (III)

or XCH(R³)COOH (IV)
and
(b) quenching the reaction mixture with a hydrogen solvent;
   wherein
   R¹ is hydrogen, or alkyl; R² is alkyl, or alkenyl, Y is OR⁴, OCOR⁵, NR⁶R⁷, or halogen; R³ is hydrogen, or alkyl, X is halogen, R⁴, R⁵, R⁶ and Rare independently on each other alkyl, alkenyl, alkynyl aryl, or arylalkyl.
   According to this method, bulk functionalization of polyamide 46 is obtained at low pH and continuous phase. Mixed solvents of formic acid and DMSO can completely dissolve polyamide 46 into continuous phase. Aluminum chloride catalyst employed in the reaction with aldehyde (II) acts as amide activator.

In the present invention, one of the most resistant aliphatic polyamide (polyamide 46) is modified to semi-permeable polyamide 46. After the modification, water absorbency was determined by contact angle measurement and results show a considerable surface tension enhancement of 44.6 mJ/m² at 20° C. Furthermore, higher crystallinity and higher melting point of hydroxyethyl modified polyamide 46 was obtained. The melting temperature after the modification was increase from 289 to 290° C. This method showed the maximum extent of modification of 95.65% after 3 h reaction.

The modified polyamide 46 generated according to the present invention shows a broad range of new properties, which opens for many new applications.

Hydroxylated polyamide 46 as an alternative for cellulose could be used in: wound dressing, implant, artificial bone, artificial kidney, low price membrane, synthetic strong sheets, fuel cell, anti fog packages, breathable packages, and textile. The strong linear covalence bond compare to weak cyclic ether bond in cellulosic compounds could develop applications of this product in wide areas.

Carboxylated polyamide 46 could be used as: ion-exchanger, color fixer in textile industry, matrix for immobilizer of nano-particles, metal remover polymer and low price anionic membrane. The carboxylic acid pendant groups can easily react with cationic groups generating strong ionic bonds.

Cationic polyamide 46 could be used as deodorant, anti-microbial agent, membrane, softener and conditioner, color fixer in textile industry, ion-exchanger and air conditioner filters.

These applications can be accomplished in many purposes which are not reported earlier using cellulose or cellulose derivative individually. Moreover, hydrophilic derivatives of cellulose do not have sufficient mechanical properties and most of them have been represented as hydrogels, while hydrophilized polyamide 46 as semi-permeable polymers have sufficient mechanical properties and possibility to change the shape and pore size as film, fabric, coating, tube, spheres, and suspension. The shape modification due to capability of dissolving in solvents is the main advantage of the present invention as it is required for changing in shape of the final product which is not seen in cellulose. This property leads to the possibility of generating very thin layer film (500 nm) for specific purposes.

### NOMENCLATURE

CAM: Contact angle measurement
DSC: Diffraction scanning calorimetry
γ_{SL}: Surface tension between solid and liquid

### PA: Polyamide

TGA: Thermogravimetric analysis
Tₘ: Melting temperature
T_{c}: Crystallization temperature

### REFERENCES

[1] K. Pielichowski, J. Njuguna, B. Janowski, J. Pielichowski, Advances in polymer science 2006, 201, 225-296.
[2] Amlan Raya, Yury V. Kissina, Keming Zhua, Alan S. Goldmana, A. E. Chemanb, G. W. Coates, Journal of Molecular Catalysis A: Chemical 2006, 256.
[3] Meister, Polymer modification: principles, techniques, and applications, Marcel Dekker, 2000.
[4] A. B. Take, S. H. Baysal, Process Biochemistry 2006, 42, 439-433.
[5] F. M. Herman, Encyclopedia of Polymer Science and Technology, Vol. 3, Wiley-Interscience, 2004.
[6] M. E. Schrader, G. I. Loeb, Modern approach to wettability: Theory and applications., Plenum Press, New York, 1992.
[7] B. H. Stuart, Infrared spectroscopy: fundamentals and applications, Wiley, New York, 2004.
[8] Eric Bon, Dennis C. H. Bigg, G. Bertrand, The Journal of Organic Chemistry 1994, 59, 4035-4036; bNickeisha A. Stephenson, Jiang Zhu, Samuel H. Gellman, Shannon S. Stahl, Journal of the American Chemical Society, 2009, 131, 10003-10008.
[9] Zhang Yu-zhu, P. Yvonne, R. Henrich, Protein Science 1995, 4, 804-814.
[10] Workman, J. L. Weyer, Practical guide to interpretive near-infrared spectroscopy., CRC Press, Florida, 2008.
[11] Robert M. Silverstein, Francis X. Webster, David J. Kiemle, Spectrometric Identification of Organic Compounds, Johan Wiley & Sons, New Jersey, 2005.

1. A substance comprising a bulk derivative of polyamide 46 and having formula I
[—NH—CH₂—CH₂—CH₂—CH₂—NR—CO—CH₂—CH₂—CH₂—CH₂—CO—]ₙ (formula I)
wherein R is hydroxyalkyl, acyl or carboxyalkyl and n is a natural number between 50 and 500, preferably between 100 and 150, more preferred between 115 and 125.

2. A substance of claim 1, wherein the alkyl in the named hydroxyalkyl group is methyl, ethyl or propyl.

3. A substance of claim 1, wherein named acyl is maleate or succinate.

4. A substance of claim 1, wherein the alkyl in the named carboxyalkyl group is methyl or ethyl.

5. A method for preparing the substance of claim 1, wherein the method comprises:
(a) reacting the polyamide 46 with an aldehyde having formula (II), or a carbonyl compound having formula (III) or a carboxylic acid having formula (IV)
R¹COH (II),
R²COY (III)
or XCH(R³)COOH (IV)
and
(b) quenching the reaction mixture with a hydrogen solvent;
wherein
R¹ is hydrogen, or alkyl; R² is alkyl, or alkenyl, Y is OR⁴, OCOR⁵, NR⁶R⁷, or halogen; R³ is hydrogen, or alkyl, X is halogen, R⁴, R⁵, R⁶ and Rare independently on each other alkyl, alkenyl, alkynyl aryl, or arylalkyl.

6. A method of claim 5, wherein R¹ is hydrogen, methyl or ethyl.

7. A method of claim 6, wherein the reaction (a) takes place in the presence of a Lewis acid.

8. A method of claim 7, wherein the Lewis acid is AlCl₃.

9. A method of claim 5, wherein the said carbonyl compound (III) is an acid anhydride.

10. A method of claim 9, wherein the acid anhydride is maleic anhydride, or succinic anhydride.

11. A method of claim 5, wherein R³ is hydrogen or methyl, and X is Cl.

12. A means for the synthesis of a substance of claim 1 based on a method of claim 5.

13. A means for the synthesis of claim 12, wherein the reaction (a) with the named aldehyde (II) takes place in the presence of a Lewis acid.

14. A means of claim 13, wherein the Lewis acid is AlCl₃.

15. Use of a substance according to any of claims 1 to 4, for the manufacturing of wound dressing, implant, artificial bone, artificial kidney, anionic or uncharged membrane, synthetic strong sheets, fuel cell, anti fog packages, breathable packages, textile, ion-exchanger, color fixer in textile industry, matrix for immobilizer of nano-particles, metal remover polymer, deodorant, anti-microbial agent, softener and conditioner, and air conditioner filters.
